(19) United States
(12) Patent Application Publication
(10) Pub. No.: US 2018/0341975 A1
(43) Pub. Date: Nov. 29, 2018

(54) METHODS FOR WEB OPTIMIZATION AND EXPERIMENTATION

(71) Applicant: Streamlet Data, La Jolla, CA (US)

(72) Inventor: Ian Edward Fellows, La Jolla, CA (US)

(21) Appl. No.: 15/987,468

(22) Filed: May 23, 2018

Related U.S. Application Data
(60) Provisional application No. 62/510,031, filed on May 23, 2017.

(51) Int. Cl. G06Q 30/02; G06F 17/30

(52) U.S. Cl. CPC G06Q 30/0242; G06F 17/30905

(57) ABSTRACT

Experiments are used to optimize web pages. The effectiveness of these optimizations depends heavily on the analytics provided by the experimental analysis system. This invention is a new type of experimental analysis system that provides the user with sequentially valid analytics focused on the key performance indicators of interest such as % improvement and avoids multiple comparison problems through multivariate testing procedures.

### PRIORITY CLAIM

This patent document claims the benefit of priority of U.S. Provisional Patent Application No. 62/510,031, filed on May 23, 2017. The entire content of the before-mentioned patent application is incorporated by reference herein.

### BACKGROUND

Web technologies have become an indispensable part of today's life for delivering information, conducting collaborative research, e-commerce applications, and entertainment, to name a few. User satisfaction often depends on the responsiveness of web servers and the format in which the information is presented. Efficient operation of web servers in turn depends on streamlining the number of web pages presented and the format in which the web pages are presented to the users.

### BRIEF SUMMARY

Techniques for improving performance of a web server are disclosed.

In one aspect, a method of providing sequentially valid inference in sequential experimentation is disclosed. The method includes receiving experimental data including the desired key performance indicators, experiment goal, visitor goal values, visitor experimental variations, and implementing a limited information method for sequential analysis. The sequential analysis is based on information contained in parameter estimates and an estimate of covariance of the parameters to generate analytics for the experimental data.

In another aspect, a computer-implemented system that implements the above-recited method is disclosed. The system may also provide statistical p-values and confidence intervals.

In yet another aspect, the above-described technique is embodied in the form of computer-executable code and stored on a computer-readable medium.

In yet another aspect, an apparatus comprising a processor is disclosed. The processor may be programmed to implement the above-described method.

### BRIEF DESCRIPTION OF THE DRAWINGS

For a more complete understanding of the disclosed techniques, reference is made to the following description and accompanying drawings.

FIG. 1 is a diagram of an embodiment of the Experiment Operational System.

FIG. 2 is an example depiction of data flow within an embodiment.

FIG. 3 shows an example of an experiment optimization engine.

FIG. 4 is a flowchart of an example method for performing web optimization and experimentation.

FIG. 5 is a block diagram example of an apparatus.

FIG. 6 illustrates examples of experimental results obtained in some embodiments.

### DETAILED DESCRIPTION

To provide a satisfactory web experience to users and to streamlines the operation of web servers, web sites are often looking for ways by which to understand what a user wants and how to provide information in a way that users will find attractive. Such improvements by web servers not only can improve user experience, but also improve the efficiency of operation by possibly reducing web traffic and the amount of computational and storage resources needed by a web server.

A/B Testing has a ubiquitous presence in the world of online marketing and is a standard tool used to optimize the performance of websites, Ad content, e-mail campaigns, and other content.

An A/B test is a multi-arm randomized controlled trial comparing a number of different versions of a page or site (known as variants) to one another on an outcome metric that may be binary, ordinal or continuous. Particular attention may be put on the case of a binary outcome metric, which usually represents a “Conversion” (e.g., a user signed up for a service, clicked an ad, or bought an item).

When testing which variation of a web page achieves a given objective, e.g., conversion, the A/B test may be used to collect data about resource utilization and/or user behavior for various versions of a web page. Decisions regarding user preferences and efficiency of operation are made on a streaming, or ongoing, basis. Because data is observed sequentially, and decision making is done in an ongoing basis, rather than once a proscribed sample size is reached, typical statistical methods of analysis may yield invalid results. The inaccuracy in results may occur due to early termination of the version testing, or may occur because the decision drawn from the number of observations made may be inaccurate. Broadly speaking, the decisions may be made during such online experimentation using hypothesis testing or Bayesian testing.

Currently available solutions typically provide sequentially valid inferences and confidence intervals. The solutions are limited to only a small number of statistical measures, specifically, the mean difference and difference in proportion indicators. Some prior art solutions also require the full specification of the likelihood, limiting their use in practice because only the asymptotic distribution of the indicators is known in some applications. Additionally, prior art has been limited to the utilization of false discovery rate (FDR) adjustment for multiple comparisons.

The solutions provided herein can be used to implement embodiments that overcome the above discussed deficiencies, and more. For example, some embodiments may implement a true multivariate statistical test, which limits type I error.

Briefly, and in general terms, the techniques described herein can be implemented in experiments where decisions are made on an ongoing basis using a stream of observations. The disclosed techniques are beneficial to the operation of web servers and other automated information serving process by providing an efficiency of operation to the web servers by allowing ongoing monitoring and continual detection of user preferences and optimizing resource utilization of the web server based on the analysis. For example, a confidence value may be generated and displayed on a user interface to enable a decision regarding continuing to allocate resources to ongoing experimentation (e.g., A/B/analysis) or terminating the analysis.

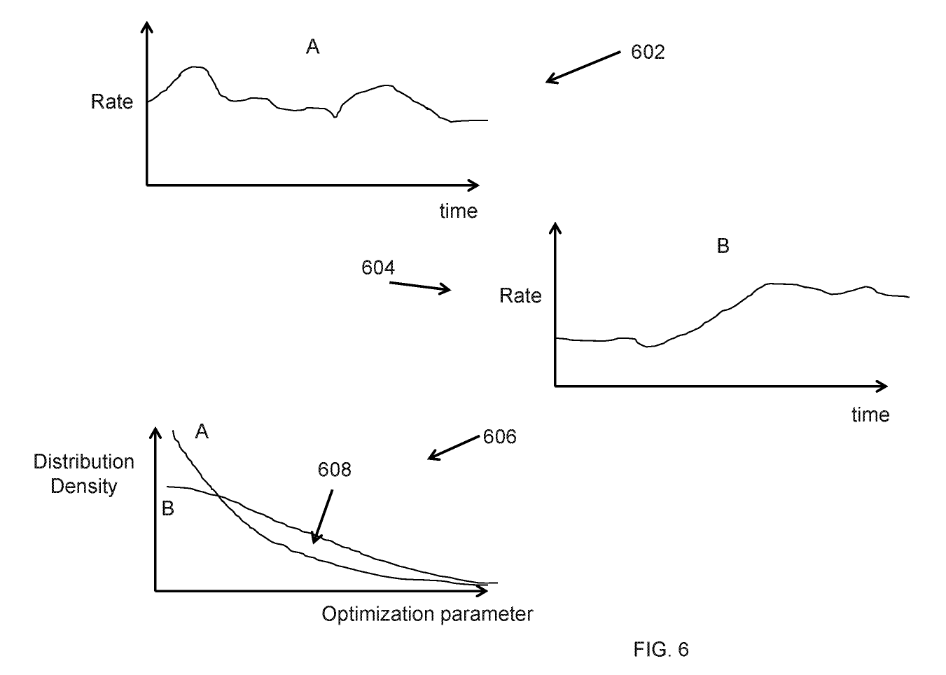

FIG. 6 shows a simplified example of A/B testing in which two versions of a given web page feature may be being tested. A particular parameter may be measured for each of these versions and observations may be made over a period of time regarding how this parameter is being achieved. For example, graph 602 represents an example of results obtained (rate) for version A of a web page as a function of time while graph 604 represents similar observations for version B. The “rate” may refer to how often users perform an action desired by the web site operator when the users are on the web page. For example, in some experiments, results of whether or not users are making purchases, or clicking on a “next page” option, or scrolling to the bottom of the page, etc. may be observed and tracked. When an experiment begins, the web site operator may not have any data about whether users prefer version A or version B. However, over a period of time, more and more samples may be collected, thereby providing a better picture of user preferences.

Without performing statistical analysis, the experimental system that performs the comparison between versions A and B may not be able to determine when the results of the comparison experiments are stable enough to present to the web site operator. The techniques described in the present document can be used to provide such a deterministic measure of when the results of observation reach a certain level of stability or accuracy and thus can be used for further (non-experimental) operation of the web server. As shown in the graph 606, the area 608 between the distribution functions of A and B shows the relative improvement in B over A in the case of continuous or ordinal outcomes, and may be calculated by some embodiments using the technique disclosed herein. Equation 14 shows how area under the curve is calculated, and equations 15 through 19 with Equation 7 may be utilized to provide sequentially valid testing for the quantity.

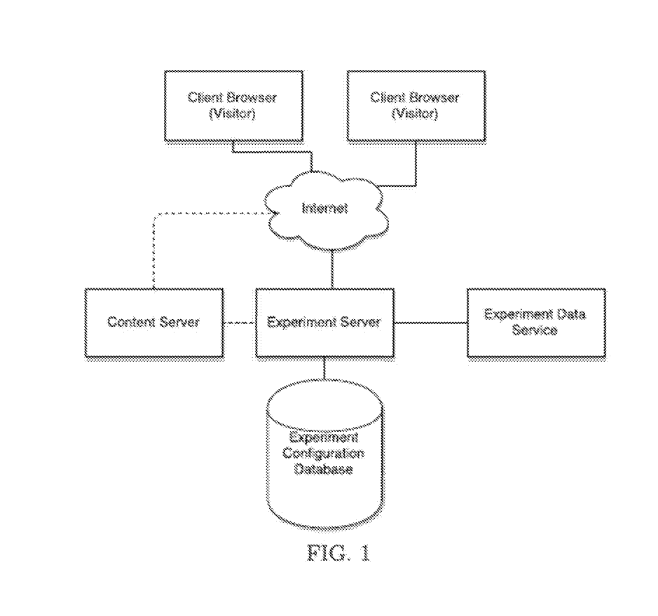

FIG. 1 shows an example embodiment of an Experiment Operational System. In this system the user experience for a visitor to a web site is determined in part by general content, and in part by a randomized experiment.

The Content Server is a web server providing the default experience for visitors of a web site. This content is generally served to client browsers through the Internet (or alternatively another communications network system) In the case of an experiment, the content provided by the server is mediated by the Experiment Server.

The Experiment Server is a web service, providing an application program interface (API) which may determine, based on variables such as browsing history and visitor attributes, whether a particular visitor is eligible for enrollment in each experiment. In some experiments, every visitor of the website within a test time window may be considered to be eligible for enrollment in the experiment. If a visitor is eligible, then the server may randomize (e.g., through the use of a pseudo-random number generator) and assign one of several variants (also known as arms of the experiment) of the default user experience. For example, a default user experience may have blue-colored selection buttons, or may have user menu placed in the top-left corner of the display, while other variants may have other shades of blue or other color, or have user menu placed in other positions on the screen. Both the conditions for enrollment and the results of the randomization may be stored in the Experiment Configuration Database. In some embodiments, this database may be implemented as a scalable MongoDB database.

In a server-side content experiment, the content server changes the user experience it serves to the visitor clients based on the randomization. In a client-side content experiment, the content server adds JavaScript instructions to visitors' content for them to query the experiment server for additional content. The Experiment server, based on the results of the randomization, sends the visitor clients JavaScript code that alters their experience to the desired variant of the default.

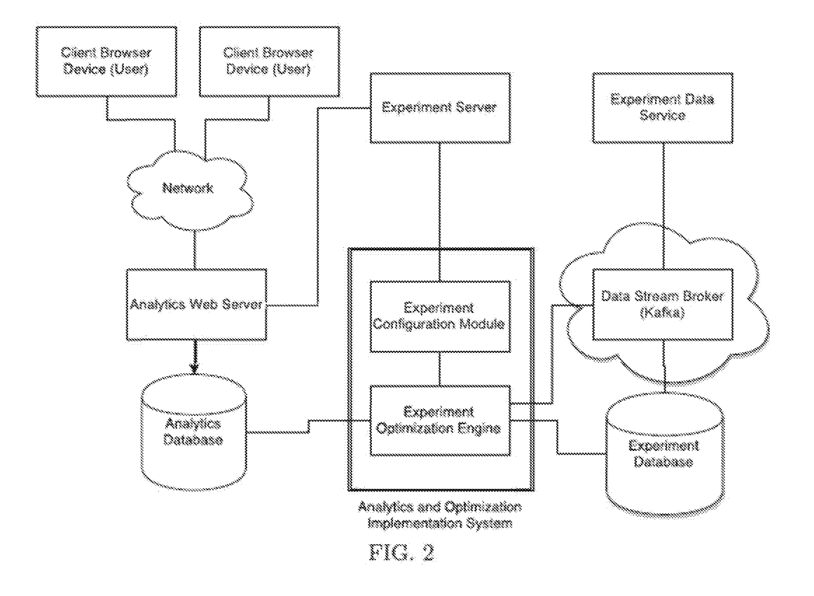

As visitors navigate the website and are randomized, data related to their interaction with the website is put on the Experiment Data Service stream, which is a producer to the Data Stream Broker (see FIG. 2). This data may include website performance indicators such as whether the visitor “Converted,” how much time they spend on the site, and how much money the visitor spent on the site. The data may also include the randomization assignments for the visitor, and additional attributes such as visitor location or time of day.

FIG. 2 shows an example of the structure and data flow of the analytics system.

The Experiment Data Service forwards the experimental data to the Data Stream Broker. The Data Stream Broker mediates the interactions between this data stream and various consumers of the stream. The Data Stream Broker may be implemented as a Kafka distributed streaming platform. One of these functional modules may be responsible for storing the data into the Experiment Database.

The Experiment Database may be a long term storage system (e.g., collecting data over a week or more) for raw experiment data. This may be implemented as scalable MongoDB cluster.

An Analytic and Optimization Implementation system may include an Experiment Optimization Engine and an Experiment Configuration module. The Experiment Optimization Engine may take the user data stream from the Data Stream Broker and from the Experiment Database. The Experiment Optimization Engine applies sequentially valid analysis to the desired key performance indicators (described in detail in this document), and forwards the results to the Analytics Database. The Analytics Database may be implemented as a scalable MongoDB cluster and may house processed analytical results such as p-values and confidence intervals.

The Analytics Web Server may be implemented the results created by the Experiment Optimization Engine to display the results to the user so that they may make optimal decisions regarding whether to terminate the test, and which variant to choose on an ongoing basis. Alternatively, if the experiment was set up as an automated test, the Analytics Web Server communicates directly with the Experiment Server, providing the decision to continue the test, alter it, or terminate and accept a variant. The Analytics Web Server may also be communicatively accessible via multiple client browser devices over a network such as the Internet.

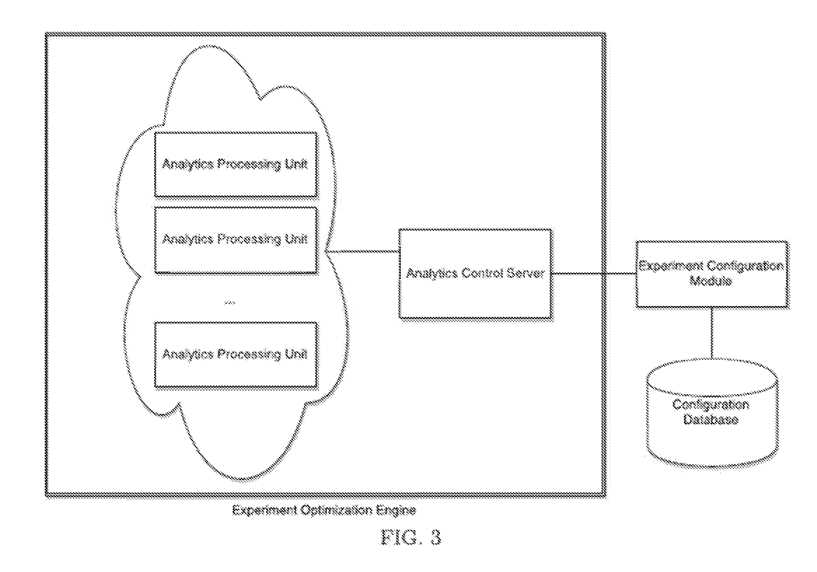

FIG. 3 shows a detailed view of an example implementation of the Experiment Optimization Engine. The Analytics, or experiment, Configuration Module provides mechanisms for storing and changing configuration parameters for experimental tests. This includes values controlling the prior distribution parameters of g (discussed below). The Analytics Control Server may take the configuration parameters and data from experiments, and dispatch them to the computation to one or more Analytics Processing Units. The Analytics Processing Units may be a scalable cloud of worker systems that perform the computationally intensive analytics.

Examples of Analytics Performed by the Experiment Optimization Engine

One example implementation may be to test the hypothesis H₀:β₁=β₀ for some family of probability distributions f(x|β), where β is a vector of parameters. In a sequential experiment, may observe a sequence of observations from this distribution X₁, X₂, . . . X_{∞}, and wish to determine a stopping rule T, which may at any point in the sequence reject the null hypothesis and terminate the experiment. The sequential likelihood ratio of β₁ versus β₀ is defined as:

$${L}_{n} = {\prod }_{i = 1}^{n} \frac{f ( {X}_{1} , … , {X}_{n} \vert {β}_{1} )}{f ( {X}_{1} , … , {X}_{n} \vert {β}_{0} )} \qquad ( 1 )$$

Analogous to the likelihood ratio test in classical statistics, in some embodiments, H₀ may be rejected when the sequential likelihood ratio rose above a certain level. Based on the fact that Lₙ is a martingale, derived type I error probabilities for this test based on the identity:

P_{β}_{₀}(max Lₙ≥α⁻¹)≤α (2)

This identity guarantees that rejecting the null hypothesis when the likelihood ratio attains a value of 1/α provides an error rate less than or equal to α.

For the majority of real world analyses, the hypotheses are composite rather than simple, which complicates the problem considerably. Researchers have considered a number of different generalizations to the Wald sequential likelihood ratio, including the adaptive likelihood ratio and the sequential generalized likelihood ratio. Some example embodiments may use, or be similar to, a mixture likelihood ratio test (mSPRT), which averages the numerator over a specified prior distribution (g) for β.

$${Λ}_{n} = \frac{f {\prod }_{i}^{n} f ( {X}_{i} \vert β ) g ( β ) d β}{{\prod }_{i}^{n} f ( {X}_{i} \vert {β}_{0} )} . \qquad ( 3 )$$

The mixture likelihood ratio then rejects the null hypothesis when:

$$T ( α ) = {Λ}_{n} > \frac{1}{α} , \qquad ( 4 )$$

and terminates the experiment and rejects the null hypothesis at sample size:

$${τ}_{G} = inf \{ n \geq 1 \text{:} {Λ}_{n}^{g} > \frac{1}{α} \} . \qquad ( 5 )$$

Similar to Lₙ, the parameter Λₙ is a martingale, and thus the mixture likelihood ratio test is guaranteed to be a level alpha test, in that under the null hypothesis the probability of terminating can be represented as:

P(τ_{G}<∞)≤α (6)

For large scale experiments implementations may be particularly interested in the large sample behavior of the mSPRT and asymptotic approximations of it. Examination of the large sample characteristics of sequential tests is known in the art.

Let \hat{β}ₙ (X₁, . . . , Xₙ) be a consistent estimator for a parameter vector β, which conditional upon X₁, . . . , Xₙ₋₁ is a one-to-one function of Xₙ. Given a known sampling distribution for \hat{β}ₙ, it is useful to create a valid sequential hypothesis test based on this distribution.

Let

$$\sqrt{n} {\hat{Σ}}_{n}^{- \frac{1}{2}} ( {\hat{β}}_{n} - β ) {⇒}^{d} 𝒩 ( 0 , I ) ,$$

where l is the identity matrix and \hat{Σ}ₙ is a consistent estimate of the limiting covariance when H₀ is true (Σ(β⁰)). Embodiments may use the following to construct tests and confidence intervals:

$${Λ}_{n}^{′} = \frac{\int φ ( {\hat{β}}_{n} \vert β , {n}^{- 1} {\hat{Σ}}_{n} ) g ( β ) d β}{φ ( {\hat{β}}_{n} \vert {β}^{0} , {n}^{- 1} {\hat{Σ}}_{n} )} . \qquad ( 7 )$$

While the above equation has a similar form to the mSPRT (see Equation 3), it is a distinct quantity. Equation 7 does not use the likelihood of the data (as the mSPRT does), but rather a “limited information” version, which includes only the information contained in the parameter estimates. Further, the true covariance of the estimates is replaced by an estimate.

The analysis thus far has avoided putting a defined functional form on the prior under the alternative hypothesis g. While in principle any distribution may be selected, computing the mixture integral numerically for each observation can be prohibitively computationally expensive, especially in the case of online experiments, where the number of observations is typically greater than 10,000, and may scale up to the millions. Fortunately, embodiments may be able to use a family of distributions that is both flexible enough to approximate any arbitrary distribution while providing a closed form solution to the integral.

Let g′ be a multivariate mixture normal density with r components

$${g}^{′} ( β ) = {\sum }_{i = 1}^{r} φ ( β \vert {μ}_{i} , {ϒ}_{i} ) {ω}_{i} , \qquad ( 8 )$$

where wᵢ is the probability of selecting the ith component. Let Λₙ be a a sequential test of the form of Equation [eq:st] Given g=g′, the test simplifies to:

$$\frac{{\sum }_{i}^{r} φ ( {\hat{β}}_{n} \vert {μ}_{i} , {\hat{Σ}}_{n} + {ϒ}_{i} ) {w}_{i}}{φ ( {\hat{β}}_{k} \vert {β}_{0} , {\hat{Σ}}_{n} )} , \qquad ( 9 )$$

removing the need for numeric integration. The mixture normal distribution allows embodiments to efficiently represent most distributions with just a few components and also allows us the flexibility to model any continuous distribution by simply increasing the number of terms.

Another aspect of the method is the possibility that g is not known exactly, but is consistently estimated by ĝₙ. In this case embodiments may use the following modified version of Equation 7 to utilize the approximation.

$${Λ}_{n}^{′} = \frac{\int φ ( {\hat{β}}_{n} \vert β , {n}^{- 1} {\hat{Σ}}_{n} ) {\hat{g}}_{n} ( β ) d β}{φ ( {\hat{β}}_{n} \vert {β}^{0} , {n}^{- 1} {\hat{Σ}}_{n} )} . \qquad ( 10 )$$

This can be especially useful in cases where it is preferable to put a prior distribution on an effect size rather than the raw β. For example if β=μ₂−μ₁ is the mean difference between two groups, embodiments may want a prior that is independent to scale transformations. So one prior distribution might be:

β˜Normal(0,σ̅²τ²) (11)

where σ̅ is any measure of the scale of the distribution, and might be the standard deviation of the first group, or a combined standard deviation from both groups, or the median absolute deviation. Given an estimate we

$${{σ}^{\hat{\_}}}_{n}$$

approximate this prior with

ĝₙ(β)=ϕ(β|0,\hat{σ}ₙ²τ²). (12)

One of the most common goals for an online A/B test is to determine whether one arm of the trial leads to more “conversions” than the others. A conversion might indicate signing up for a newsletter, a purchase, clicking on an Ad, or any other positive action by the user. The outcome is therefore a Bernoulli random variable Xᵢ˜Ber(p_{γ}_{ᵢ}), where Yᵢ ∈ {1, . . . , m} is the arm assigned to the ith individual. The maximum likelihood estimators of p are simply the sample proportions within each group

$${\hat{p}}_{j} = \frac{1}{{n}_{j}} {\sum }_{i} {X}_{i} 1 ( {Y}_{i} = j ) ,$$

where 1 is the indicator function and nⱼ=Σᵢ 1 (Yᵢ=j).

For numeric and ordinal outcomes, instead of being distributed binomially, the outcome is distributed according to Xᵢ˜f_{Y}_{ᵢ}, where f_{Y}_{ᵢ} is the distribution of the ith arm of the study. The group means and standard deviations are

$${\hat{μ}}_{j} = \frac{1}{{n}_{j}} {\sum }_{i} {X}_{i} 1 ( {Y}_{i} = j ) and {\hat{σ}}_{j}^{2} = \frac{1}{{n}_{j} - 1} {\sum }_{i} ( {X}_{i} - {\hat{μ}}_{j} ) 1 ( {Y}_{i} = j ) .$$

Many applications in online testing involve outcomes with heavy tails and high skews. The presence of outliers due either to exceptional users, or data collection errors, may factor into choosing appropriate methodologies for analysis.

For heavy tailed distributions with outliers, the mean, as a measure of central tendency, is a questionable choice. The mean is heavily influenced by the tail behavior of a distribution, and thus any test based on mean differences will require large sample sizes to reach significance. Further, the result of that test may be dominated by the behavior of a minority of exceptional users rather than representing the effects of the experiment on the majority.

Another use case of interest is ordinal data, which, while ordered, does not have an intrinsic unit of measurement. Examples from online testing might be the number of steps a user took through the registration process, or a user selected product rating from “Very good” to “Very Poor.” Using means to measure the central tendency of an ordinal variable imposes an arbitrary unit on the variable, which may not be appropriate.

TABLE 0.1
Limited information likelihoods for key performance indicators.

| Indicator | \hat{β}ᵢ | Diag. Cov. (n⁻¹\hat{Σ}ᵢᵢ) | Off-diag. Cov. (n⁻¹\hat{Σ}ᵢⱼ) |
|---|---|---|---|
| Risk Ratio | log(\hat{p}ᵢ₊₁) − log(\hat{p}₁) | $\frac{1 - {\hat{p}}_{i + 1}}{{\hat{p}}_{i + 1} {n}_{i + 1}} + \frac{1 - {\hat{p}}_{1}}{{\hat{p}}_{1} {n}_{1}}$ | $\frac{1 - {\hat{p}}_{1}}{{\hat{p}}_{1} {n}_{1}}$ |
| Odds Ratio | $log ( \frac{{\hat{p}}_{i + 1}}{1 - {\hat{p}}_{i + 1}} ) - log ( \frac{{\hat{p}}_{1}}{1 - {\hat{p}}_{1}} )$ | $\frac{1}{{n}_{i} {\hat{p}}_{i}} + \frac{1}{{n}_{i - 1} ( 1 - {\hat{p}}_{i - 1} )} + \frac{1}{{n}_{1} {\hat{p}}_{1}} + \frac{1}{{n}_{1} ( 1 - {\hat{p}}_{1} )}$ | $\frac{1}{{n}_{1} {\hat{p}}_{1}} + \frac{1}{{n}_{1} ( 1 - {\hat{p}}_{1} )}$ |
| Prop. Diff. | \hat{p}ᵢ₊₁− \hat{p}₁ | $\frac{{\hat{p}}_{i + 1} ( 1 - {\hat{p}}_{i + 1} )}{{n}_{i + 1}} + \frac{{\hat{p}}_{1} ( 1 - {\hat{p}}_{1} )}{{n}_{1}}$ | $\frac{{\hat{p}}_{1} ( 1 - {\hat{p}}_{1} )}{{n}_{1}}$ |
| Mean Diff. | \hat{μ}ᵢ₊₁− \hat{μ}₁ | $\frac{{\hat{σ}}_{i + 1}^{2}}{{n}_{i + 1}} + \frac{{\hat{σ}}_{1}^{2}}{{n}_{1}}$ | $\frac{{\hat{σ}}_{1}^{2}}{{n}_{1}}$ |
| AUC | See Equation 4 | See Equation 6 | See Equation 7 |

Addressing both the continuous and ordinal case in the comparison of two samples is known as the Nonparametric Behrens-Fisher Problem. In the non-sequential context, some implementations have developed a two-sample test that shows good small sample characteristics.

Let gᵢ be the indexes of X belonging to group i, then the treatment effect of group i over group 1 is defined as

$${p}_{i} = P ( {X}_{{( {g}_{1} )}_{1}} < {X}_{{( {g}_{i} )}_{1}} ) + \frac{1}{2} P ( {X}_{{( {g}_{1} )}_{1}} = {X}_{{( {g}_{i} )}_{1}} ) . \qquad ( 13 )$$

The interpretation of this treatment effect is that pᵢ is the probability that a random chosen member of group i has a higher value of X than a randomly chosen member of group 1, plus 0.5 times the probability that they tie. If the two distributions are equal, then pᵢ=0.5. If group i tends to have higher values, then 0.5<pᵢ≤1 and if it tends to have lower values then 0≤pᵢ<0.5. pᵢ is also known as the area under the curve (AUC).

In some embodiments, the normalized distribution function may be defined as

$${F}_{i} ( x ) = \frac{1}{2} ( {F}_{i}^{-} ( x ) + {F}_{i}^{+} ( x ) ) ,$$

where Fᵢ⁻(x)=P(X_{(g}_{ᵢ}₎_{₁}<x) is the left continuous distribution function and Fᵢ⁺(x)=P(X_{(g}_{ᵢ}₎_{₁}≤x) is the right continuous version. Empirical approximations \hat{F} of F may be estimated by replacing the probabilities by their sample analogs. Further, embodiments may use the mid-rank of each Xⱼ as Rⱼ, and

$${\overline{R}}_{i} = \frac{1}{{n}_{i}} {\sum }_{j ∈ {g}_{i}} {R}_{j}$$

to be the observed mean rank of group i. An unbiased estimate of pᵢ is then

$${\hat{p}}_{i} = \int {\hat{F}}_{1} d {\hat{F}}_{i} = \frac{1}{{n}_{1}} ( {\overline{R}}_{i} - \frac{{n}_{i} - 1}{2} ) . \qquad ( 14 )$$

A large sample inference may thus be possible by showing that asymptotically,

$$\sqrt{n} ( {\hat{p}}_{i} - {p}_{i} ) ⇒ {U}_{n} = \sqrt{n} ( \frac{1}{{n}_{i}} {\sum }_{j ∈ {g}_{i}} {F}_{1} ( {X}_{j} ) - \frac{1}{{n}_{1}} {\sum }_{j ∈ {g}_{1}} {F}_{i} ( {X}_{j} ) + 1 - 2 {p}_{i} ) . \qquad ( 15 )$$

The right hand side of Equation 15 is the difference of two sums of independent variables, and thus the central limit theorem may be invoked for asymptotic normality. The variance may be expressed as

$$var ( {U}_{n} ) = n ( \frac{{v}_{i}^{2}}{{n}_{1}} + \frac{{σ}_{i}^{2}}{{n}_{i}} ) , \qquad ( 16 )$$

where σᵢ²=var(Fᵢ(X_{(g}_{₁}₎_{₁})) and v²=var(F₁(X_{(g}_{ᵢ}₎_{₁})). σ and v may be consistently approximated by \hat{σ}ᵢ²=vâr(\hat{F}ᵢ(X_{(g}_{₁}₎_{₁})) and \hat{v}²=vâr(\hat{F}₁(X_{(g}_{ᵢ}₎_{₁})), where var is the sample variance. So, the asymptotic distribution of \hat{p}ᵢ may be approximated as

$${\hat{p}}_{i} \sim N ( {p}_{i} , \frac{{\hat{v}}_{i}^{2}}{{n}_{1}} + \frac{{\hat{σ}}_{i}^{2}}{{n}_{i}} ) \qquad ( 17 )$$

The asymptotic distribution of \hat{p} is normal, and the diagonal terms of the covariance matrix are

$${n}^{- 1} {\hat{Σ}}_{ii} = \frac{{\hat{v}}_{i}^{2}}{{n}_{1}} + \frac{{\hat{σ}}_{i}^{2}}{{n}_{i}} . \qquad ( 18 )$$

The off-diagonal terms may be estimated noting that

$$\begin{matrix}cov ( {\hat{p}}_{l} , {\hat{p}}_{m} ) ⇒ cov ( \frac{1}{{n}_{l}} {\sum }_{j ∈ {g}_{l}} {F}_{1} ( {X}_{j} ) - \frac{1}{{n}_{1}} {\sum }_{j ∈ {g}_{1}} {F}_{l} ( {X}_{j} ) , \\ \frac{1}{{n}_{m}} {\sum }_{j ∈ {g}_{m}} {F}_{1} ( {X}_{j} ) - \frac{1}{{n}_{1}} {\sum }_{j ∈ {g}_{1}} {F}_{m} ( {X}_{j} ) ) \text{?} \\ = cov ( \frac{1}{{n}_{1}} {\sum }_{j ∈ {g}_{1}} {F}_{l} ( {X}_{j} ) , \frac{1}{{n}_{1}} {\sum }_{j ∈ {g}_{1}} {F}_{m} ( {X}_{j} ) ) \\ = \frac{1}{{n}_{1}} cov ( {F}_{l} ( {X}_{{( {g}_{1} )}_{1}} ) , {F}_{m} ( {X}_{{( {g}_{1} )}_{1}} ) ) \\ \approx {n}^{- 1} {\hat{Σ}}_{lm} = \frac{1}{{n}_{1}} \hat{cov} ( {\hat{F}}_{l} ( {X}_{{( {g}_{1} )}_{1}} ) , {\hat{F}}_{m} ( {X}_{{( {g}_{1} )}_{1}} ) ) , \text{?}\end{matrix} \\ \text{?} \text{indicates text missing or illegible when filed} \qquad ( 19 )$$

where côv is the sample covariance.

Generating a p-value or confidence using the test statistic in Equation 2 is done by finding the smallest alpha such that the test is not rejected

pvalue(n)=argmin_{α}(max_{α1, . . . ,n}Λᵢ′)<α⁻¹. (20)

A confidence set (C) for a particular a level may be generated by inverting the test statistic

$$C ( n , α ) = {β}^{0} \text{:} ( {max}_{i : 1 , … , n} \frac{\int φ ( {\hat{β}}_{n} \vert β , {n}^{- 1} {\hat{Σ}}_{n} ) g ( β ) d β}{φ ( {\hat{β}}_{n} \vert {β}^{0} , {n}^{- 1} {\hat{Σ}}_{n} )} ) < {α}^{- 1} . \qquad ( 21 )$$

A confidence set for any individual β_i∧0 is constructed as the set of all β_i∧0 such that C(n,α) contains a value where the ith term is equal to β_i∧0.

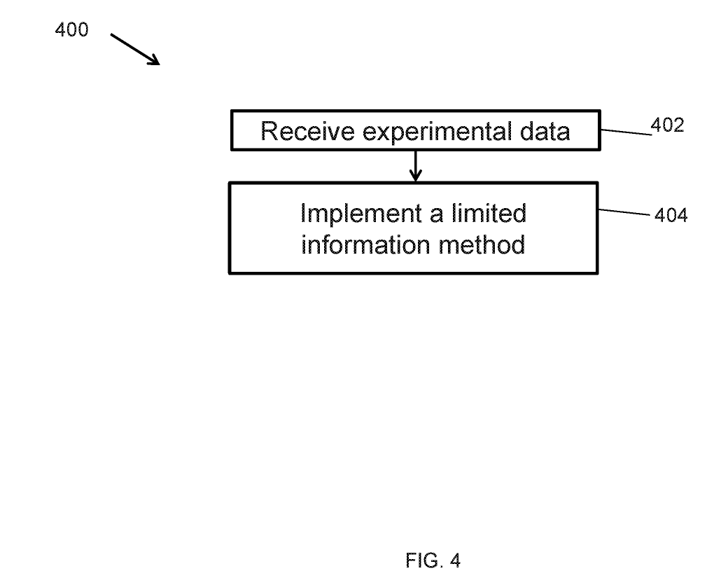

FIG. 4 is a flowchart depiction of a method 400 of improving performance of a web server. The method 400 includes, at 402, receiving experimental data including at least some of desired key performance indicators, an experiment goal, visitor goal values, visitor experimental variation. The method 400 includes, at 404, implementing a limited information method for sequential analysis based on information contained in parameter estimates and an estimate of covariance of parameters to generate analytics for the experimental data. For example, in some embodiments, the formulation shown in Equation 7 may be used. In some embodiments, the results may be displayed to a user of the system via a user interface.

In some embodiments, the method 400 may be used for optimizing the operation of a web server. For example, a website may offer various parameters of operation for a user to interact with. The parameters may include placement of content, user menus, video, graphics and so on. User behavior of many users may be tracked and analyzed using the method 400.

In some embodiments, the method 400 may automate a decision about whether to terminate or continue an experiment that is generating experimental data. In some embodiments, the p-values calculated during the experiment may be calculated using the equation

pvalue(n)=argmin_{α}(max_{α1, . . . ,n}Λᵢ′<α⁻¹.

For example, a threshold may be set for confidence values and when the experimental analysis shows that the confidence level has reached above the threshold, the experiment may be terminated.

In some embodiments, the method 400 includes calculating confidence regions using a test inversion method as described, e.g., with respect to Equation 21. In some embodiments, the method 400 may include implementing the mixture normal distribution described in Equations 8, 9, and 10.

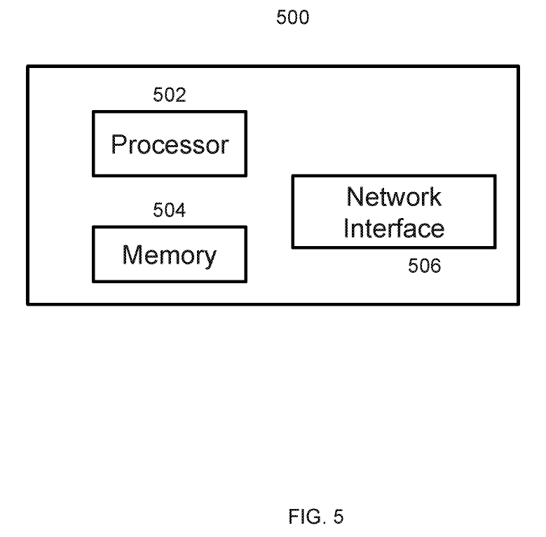

FIG. 5 shows an example apparatus 500 in which the techniques described in the present document can be embodied. The apparatus 500 includes a processor 502 that includes one or more CPUs. The apparatus includes a memory 504 that includes one or more memories. The apparatus may also include a network interface 506 using which the apparatus 500 may be able to communicate with other network equipment. Other optional interfaces such as human interaction interface, display interface, and so on are omitted from the drawing for brevity.

It will be appreciated that a computer implemented methodology for performing sequentially valid analytics on experimental data from online optimization, and displaying these analytics to the user for decision making is disclosed. Methodology to automate this decision making is also provided. The analytics provided to the user by the system includes statistical confidence intervals for performance indicators of interest to the user. For a binary outcome, these performance indicators between variants include % improvement (also known as “lift” or risk ratio), odds ratio, and difference of proportion. For a continuous outcome, indicators include mean difference and non-parametric area under the curve (AUC). For an ordinal outcome, AUC is usually the most appropriate indicator.

It will further be appreciated that the disclosed techniques can be used to implement embodiments in which a relative improvement, measured for a specific criteria, can be estimated based on ongoing observations using a limited number of observations. The techniques can be used to implement hardware or software systems that can improve the operation of web sites by allowing web site operators to optimize the design and layout of web pages, the memory footprint of web pages, the loading options, by determining which plug-in or multimedia presentation format is preferred by web site visitors, and so on. It will be appreciated that a result of the disclosed techniques, web sites can provide more compelling content to visitors and do so while reducing amount of network bandwidth used, the number of variations of a web page the web site has to store in local memory, and so on.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for providing sequentially valid inference in sequential experimentation comprising:
receiving experimental data including one or more of desired key performance indicators, an experiment goal, visitor goal values, and a visitor experimental variation; and
implementing a limited information method for sequential analysis based on information contained in parameter estimates and an estimate of covariance of parameters to generate analytics for the experimental data.

2. The method of claim 1 further comprising a system configured to display analytics to the user.

3. The method of claim 1 further comprising automating a decision of whether to terminate or continue an experiment that generates the experimental data.

4. The method of claim 1, further comprising calculating p-values and confidence values using following equation:
pvalue(n)=argmin_{α}(max_{α1, . . . ,n}Λᵢ′)<α⁻¹;
wherein pvalue(n) is a p-value of parameter n, Λ represents, and α is a level.

5. The method of claim 1, wherein sequential analysis of the risk ratio, or a transformation of the risk ratio, is performed.

6. The method of claim 1 wherein sequential analysis of the odds ratio, or a transformation of the odds ratio, is performed.

7. The method of claim 1 wherein sequential analysis of an area under curve (AUC), or a transformation of the AUC, is performed.

8. The method of claim 1, further comprising implementing a prior distribution represented by:
β˜Normal(0,σ̅²τ²),
where σ̅ is any measure of the scale of the distribution, and might be the standard deviation of the first group, or a combined standard deviation from both groups, or the median absolute deviation.

9. The method of claim 8 wherein the prior distribution has a scaling factor applied.

10. The method of claim 8 wherein the prior distribution is scaled by the standard deviation of one of the variant groups, or an average standard deviation across variant groups.

11. The method of 10 wherein a key indicator of the one or more of desired key performance indicators is a difference between group means.

12. The method of claim 10 wherein a key indicator of the one or more of desired key performance indicators is a difference between group proportions.

13. A computer program product having code stored thereupon, the code, when executed by a processor, causing the processor to implement a method for providing sequentially valid inference in sequential experimentation the code comprising;
code for receiving experimental data including one or more of desired key performance indicators, an experiment goal, visitor goal values, and a visitor experimental variation; and
code for implementing a limited information method for sequential analysis based on information contained in parameter estimates and an estimate of covariance of parameters to generate analytics for the experimental data.

14. The computer program product of claim 13, wherein the code further includes:
code for automating a decision of whether to terminate or continue an experiment that generates the experimental data.

15. The computer program product of claim 13, wherein the code further includes:
code for calculating p-values and confidence values using following equation:
pvalue(n)=argmin_{α}(max_{α1, . . . ,n}Λᵢ′)<α⁻¹;
wherein pvalue(n) is a p-value of parameter n, Λ represents, and α is a level.

16. The computer program product of claim 13, wherein the code further includes:
code for implementing a prior distribution represented by:
β˜Normal(0,σ̅²τ²),
where σ̅ is any measure of the scale of the distribution, and might be the standard deviation of the first group, or a combined standard deviation from both groups, or the median absolute deviation.

17. An apparatus comprising a memory and a processor, wherein the memory is configured to store program code and the processor is configured to read the program code from the memory and implement a method, comprising:
receiving experimental data including one or more of desired key performance indicators, an experiment goal, visitor goal values, and a visitor experimental variation; and
implementing a limited information method for sequential analysis based on information contained in parameter estimates and an estimate of covariance of parameters to generate analytics for the experimental data.

18. The apparatus of claim 17 wherein the method further includes displaying the analytics on a user interface.

19. The apparatus of claim 17, wherein the method further includes deciding to terminate or continue an experiment that generates the experimental data.

20. The apparatus of claim 17, wherein the method further includes calculating p-values and confidence values using following equation:
pvalue(n)=argmin_{α}(max_{α1, . . . ,n}Λᵢ′)<α⁻¹;
wherein pvalue(n) is a p-value of parameter n, Λ represents, and α is a level.
